(19) United States
(12) Patent Application Publication
(10) Pub. No.: US 2026/0088526 A1
(43) Pub. Date: Mar. 26, 2026

(54) CONDUCTOR TERMINAL

(71) Applicant: WAGO Verwaltungsgesellschaft mbH, Minden (DE)

(72) Inventors: Sergej ISAAK, Stedesdorf (DE); Michael MEYER, Wiedensahl (DE)

(73) Assignee: WAGO Verwaltungsgesellschaft mbH, Minden (DE)

(21) Appl. No.: 19/340,340

(22) Filed: Sep. 25, 2025

(30) Foreign Application Priority Data
Sep. 25, 2024 (DE) 20 2024 105 523.3
Jun. 30, 2025 (DE) 20 2025 103 697.5

(51) Int. Cl. H01R 4/48

(52) U.S. Cl. CPC H01R 4/4821; H01R 4/483; H01R 4/48365

(57) ABSTRACT

A conductor terminal with a clamping spring, which with a busbar forms a clamping point for clamping an electrical conductor. At least one wall element is positioned behind a passage opening of the busbar in the conductor insertion direction and delimits an insertion space for the conductor and/or has a receiving area for a functional element coupled to the busbar and/or to the clamping spring and/or that is mechanically connectable to the conductor.

This nonprovisional application claims priority under 35 U.S.C. § 119(a) to German Patent Application No. 20 2024 105 523.3, which was filed in Germany on Sep. 25, 2024, and to German Patent Application No. 20 2025 103 697.5, which was filed in Germany on Jun. 30, 2025, and which are all herein incorporated by reference.

### BACKGROUND OF THE INVENTION

### Field of the Invention

The invention relates to a conductor terminal for connecting an electrical conductor, with a busbar and with a clamping spring forming a clamping point with the busbar for clamping the conductor.

### Description of the Background Art

Such a (conductor) connection or connection terminal is typically used in such a way that a respective (conductor) clamping point must be actively opened by a user by means of a lever or pusher-like actuator, for example, before a conductor can be inserted into or at the clamping point. The actuator is then released again, which closes the clamping point and fixes the conductor to the busbar by clamping spring pressure and contacts it electrically. The conductor terminal may be designed for a single, preferably single or multi-wire, in particular fine-wire, electrical conductor or as a connecting terminal for several such conductors.

It is often desirable, especially in the case of small conductor terminals with the smallest possible dimensions or in the case of conductor terminals for the connection of electrical conductors with the smallest possible conductor cross-sections, that the open clamping point remains open without further action of the actuator and that the clamping point can be closed without an actuator, preferably by means of the conductor itself.

From DE 10 2020 119 372 B4, which corresponds to US 2022/0029332, which is incorporated herein by reference, a conductor terminal is known with an insulating material housing with a conductor insertion opening for accommodating an electrical conductor, and with a busbar having a through-hole opening for the conductor, and with a clamping spring, which forms a clamping point for the electrical conductor with the busbar. A holding element for holding a clamping arm of the clamping spring in an open position of the clamping point has a locking element that engages with a locking element on the clamping arm, and a release section for releasing the locking, which can be operated by means of the conductor, for example.

### SUMMARY OF THE INVENTION

It is therefore an object of the present invention to provide a particularly suitable electrical conductor terminal. In particular, a suitable operating mechanism for opening a clamping point between a clamping spring and a busbar and/or a suitable mechanism for locking a clamping arm of the clamping spring in an open position of the clamping point or for releasing such a locking connection should be specified.

The conductor terminal provided and equipped for the connection of an electrical conductor has a busbar and a clamping spring, which forms a clamping point with the busbar for connecting the conductor. Here and in the following, a conductor is understood in particular to be a (conductor) wire of an (electrical) cable formed by one or more wires made of electrically conductive material, such as copper, and enclosed by a conductor sheath made of an insulating material. The busbar is made in particular of copper or a copper material. The clamping spring, which is suitably designed as a leg spring or with a contact leg and with a clamping arm as well as with a spring bow connecting the legs, is preferably made of a spring steel, in particular as a stamped-bent part.

The conductor terminal can have at least one wall element that is positioned or arranged in a conductor insertion direction behind a through-hole opening of the busbar provided for the conductor to be clamped. Conveniently, the wall element delimits an insertion space for the conductor, especially within an insulating material housing of the conductor terminal. In addition or alternatively, the at least one wall element has a receiving area for a functional element that is or can be coupled with the busbar and/or the clamping spring and/or delimits such a receiving space. In this context, the wall element or each wall element may be a component of, for example, a pocket-shaped, cap-like or lid-like part of the housing (housing element), in particular by forming the receiving area or a receiving space for the functional element or a number of functional sections. The functional element, in particular a function or release section, can also be mechanically coupled to the conductor in an advantageous way.

The conductor terminal may be designed with at least one wall element that has a swivel element, for example, a lever-like or rocker-lever-like swivel element. The swivel element can be suitably mechanically coupled with a clamping arm of the clamping spring for opening the clamping point or clamping at the clamping point. The swivel element can be advantageously mounted on the wall element. In addition or alternatively, the swivel element is mounted on the busbar and/or in or on a section (bearing or function section, bearing leg) of the or a functional element, preferably as a counter bearing.

In the case of a conductor terminal designed with at least one wall element and with one functional element, the busbar can have a through-hole opening for the conductor to be clamped. In this case, the functional element is at least partially or preferably completely arranged behind the through-hole opening of the busbar or on the back of the bar arranged in the direction of conductor insertion. Suitably, the functional element has a locking section, in particular with a locking element, for creating a releasable locking connection with the or a clamping spring of the clamping arm.

The functional element can have a release section for releasing the or a locking connection between the clamping arm of the clamping spring and a locking element, in particular the locking section of the functional element. The functional element can have a section (bearing or function section) for supporting a swivel element, in particular a lever-like one, which is mechanically coupled to the clamping spring or to its clamping arm for opening the clamping at the clamping point.

According to, for example, an expedient design, in the case of a conductor terminal designed with a functional element arranged at least partly behind a through-hole opening of the busbar, preferably in the direction of conductor insertion, the busbar can have at least one section of wall or collar. This is suitably located at or in the area of the through-hole opening of the busbar.

The wall section (collar section) can be oriented in the direction of the conductor insertion to the functional element or is provided on a rail back of the busbar. The wall or collar section is preferably shaped or molded from the busbar, in particular by reshaping, for example a 90° reshaping. The through-hole opening of the busbar is particularly advantageously designed, in particular by collar forming or by push-pull forming, as a pull-through whose collar forms or has the wall section.

The functional element can have a locking section for establishing a releasable locking connection with the or a clamping arm of the clamping spring, as well as a contact section. This can be advantageously formed by a contact edge between parallel bearing legs of the functional element. With the contact section or with the contact edge, the functional element rests on a side (outer or contact side) of the wall or collar section facing away from the through-hole opening. In addition or alternatively, the clamping spring or its contact leg rests on a side of the wall or collar section facing the through-hole opening (inner side). Preferably, the contact leg is expediently supported on this side (inner side) on the wall or collar section.

In an example of the conductor terminal, which is designed with a busbar and with a clamping spring as well as with a swivel element, an insulating material housing with a conductor connecting channel accessible via an insertion opening can be provided for the conductor. The busbar suitably has the through-hole opening, which is penetrated by the conductor in the course of a conductor connection. The clamping spring or its clamping arm has a clamping edge on the leg or free-end side. Together with the busbar, in particular with a wall or collar section on the rail side, this forms the or a clamping point for the conductor. The swivel element, which is designed or effective in particular as a swivel or rocker arm, is provided or equipped for displacing or swivelling the clamping arm of the clamping spring by creating an open clamping point.

A locking element interacting with the clamping spring or its clamping arm can be provided for the creation of a locking connection that can be released by means of a release element when the clamping point is open. In addition or alternatively, a pocket-shaped or cap-like or lid-like housing part or housing element with a number of wall elements is provided. The housing part or housing element is suitably arranged (positioned) in the direction of conductor insertion behind the busbar or behind its through-hole opening. It is expedient to incorporate the housing part or housing element into the or an insulating material housing or to insert it into it.

In addition or alternatively, a functional element can be provided for supporting a swivel or actuating element, in particular for swivelling or rotationally movable, and/or for the creation or release of the locking connection and/or for the power transmission system on the busbar or on a wall or collar section, in particular on or in the area of a through-hole opening, of the busbar. Preferably, the functional element has corresponding functional sections for bearing a swivel element, for establishing the locking connection, for releasing the locking connection, for the power transmission system on the busbar or on a wall or collar section of the busbar and/or on a wall contour of the wall or housing element.

The housing element can be held on the busbar and/or on the or a wall or collar section or on the pull-through collar of the busbar. In particular, the housing element can be mounted on the busbar or pre-assembled. Appropriately, the housing element can enclose the pull-through collar of the busbar, at least partially or in sections. This enables a particularly advantageous pre-assembly of the housing element, especially with components already included in it and/or elements of the conductor terminal, preferably the functional element.

Appropriately, the housing element, preferably with a functional element inserted in it and/or together with the busbar and/or together with the clamping spring, is or can be inserted in the or an insulating material housing. The pocket-, cap-like or lid-like housing element forms an insertion and/or receiving space. Preferably, the swivel element is coupled with an actuator element designed and/or effective, in particular, as a pusher. In particular, the actuator element or pusher is guided in a guide channel of the insulating material housing in a sliding manner.

The housing element may form each of the wall elements, in particular two parallel wall elements for the support of the swivel element at opposite bearing points or bearing sections. A particularly suitable example provides that at least one wall element or housing element has a bearing section or a bearing contour that corresponds to or interacts with a bearing section or with a bearing contour of the swivel element.

The busbar can have at least one bearing contour and the swivel element has a corresponding bearing contour, which corresponds to the bearing contour of the busbar, in particular forming a rotary or swivel bearing. Suitably, the busbar, especially in the direction of the conductor insertion on the back of the rail, preferably in the area of the through-hole opening, has at least one bearing contour and the swivel element has a bearing element that engages with the bearing contour of the busbar. The busbar can also have a bearing element that engages with a corresponding bearing contour of the swivel element. The bearing element can be designed as a (standing) axis or form one around which the corresponding bearing contour slides.

The functional element can have a bearing sleeve or bearing eye forming the functional or bearing section with a, in particular arc-shaped, bearing contour, and the swivel element has at least one bearing pin or a bearing bracket with a corresponding bearing contour. This interacts with the bearing contour of the functional or bearing section, which is preferably molded to or molded from the locking section of the functional element.

The functional element can have at least one bearing leg running or arranged to the side of the through-hole opening of the busbar and the swivel element has at least one corresponding bearing contour. This interacts with the bearing leg or with a bearing contour of the bearing leg, preferably forming a counter bearing for the swivel element. Appropriately, such a bearing leg is provided on both sides of the through-hole opening, which extends over part of the length of the through-hole opening or the pull-through in the longitudinal direction of the busbar. This enables a particularly narrow conductor terminal. The bearing or counter bearing for the swivel element (rocker arm) formed by means of the bearing leg located to the side of the through-hole opening of the busbar is particularly advantageously located in the direction of conductor insertion on the rear of the busbar, directly under the contact point or attack position of the swivel element (rocker arm) on the clamping arm of the clamping spring.

The functional element can also have a locking section with a locking contour. The locking section is connected by means of a bending point, in particular knee-like, to the or a release section that interacts in particular with the conductor or can be operated or pressurized by the conductor. A recess, especially hole-like, is provided in the bending point. This advantageously enables a particularly small bending radius between the locking section and the release section.

Further, the functional element can have an angle section, especially in the direction of the busbar. In addition or alternatively, the functional element has a holding section that interacts with a holding contour of the wall element or the housing element.

The functional element shall can have a locking section with a locking contour, which is angular in particular with respect to the release section, as well as an adjoining angular section, in particular in the direction of the busbar, as well as the or a holding section connected to it, which interacts with a holding contour of the wall element or the housing element.

Expediently, the angular section of the functional element can be outside the through-hole opening of the busbar on a wall or collar section of the busbar opposite the clamping point. In addition or alternatively, the functional element is held in sections between the busbar and a housing contour of the wall element or the housing element, preferably fixed with a clamp. As a result, the functional element is particularly conveniently supported on the busbar or on its wall or collar section. This, in turn, enables a particularly expedient application of force, in particular a release force to release the locking connection, via a force chain, in particular formed by means of the functional element, the busbar and/or the wall or housing element, into the unit of the busbar and the wall or housing element, or via this unit into the or an insulating housing.

Expediently, a connecting section can be provided at an angle, in particular at a right angle, to the contact section of the functional element, which fits into an insertion contour of the wall element or the housing element or can be inserted into it. This example of the functional element serves in particular to form and/or improve the force chain.

A recess can be provided in the functional element, in particular in the holding section and/or in an angle section. This advantageously reduces the release force acting over the release section, especially by means of the conductor into the functional element.

The functional element, in particular its holding section, can have a recess aligned with an opening in the busbar and the clamping spring, in particular its contact leg, has an insertion element that engages in the recess of the functional element via the opening of the busbar, preferably in the form of pins or tabs or flat ribbons. Preferably, the holding section of the functional element is designed as a functional or bearing section or shaped in the manner of a bearing sleeve or bearing eye for the swivel element, in particular for supporting at least one corresponding bearing element or bearing journal of the swivel element.

The functional element, in particular the holding section, can have a contact section parallel to the busbar, in particular in the direction of conductor insertion at the rear of a rail. In addition or alternatively, the functional element, in particular the holding section, has a contact section parallel to the busbar and an insertion section extending at an angle thereto, in particular at an acute angle. This is located in an insertion contour or groove of the wall element or the housing element or can be inserted into it. The insertion contour is suitably formed between the housing element and the busbar and/or a housing contour of the or an insulating material housing in which the wall element or housing element is inserted.

A particularly suitable example or further development of the locking connection between the clamping arm of the clamping spring and the functional element can provide that the functional element has a notch or taper that forms at least one contact or locking edge. The clamping arm of the clamping spring has at least one locking tab, which engages behind the corresponding contact edge to form the locking connection. In addition or alternatively, the clamping arm of the clamping spring has a bending section oriented in the direction of the clamping point with a free-end clamping edge, which forms the clamping point with the busbar or with the conductor secured by a clamp.

The clamping arm of the clamping spring can have at least one locking element, in particular a tab-like or flat-band locking element. This locking element, which is primarily provided for establishing the locking connection with the functional element or with its locking or contact edge(s), extends at an angle to the or a bending section oriented in the direction of the clamping point with a clamping edge on the free end of the clamping arm of the clamping spring.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows in a side view, a conductor terminal with a view into a receiving or assembly space of an insulating material housing and the power busbar and clamping spring disposed therein,

FIG. 2 shows in a sectional diagram, the conductor terminal with a closed clamping point between a clamping arm of the clamping spring and the busbar,

FIG. 3 shows the conductor terminal with a clamping arm of the clamping spring that is swiveled via a swivel element designed as a rocker arm,

FIG. 4 shows in a sectional diagram, the conductor terminal in an open position of the clamping point with a clamping arm locked with a functional element,

FIG. 5 shows in a diagram according to FIG. 4, the conductor terminal with clamped conductor after the locking connection has been released by means of the electrical conductor,

FIG. 6 shows in a perspective view, the functional element with a number of functional sections,

FIG. 7 shows in a perspective view, the functional element and the clamping spring with the clamping arm locked in place,

FIG. 8 shows in a perspective view, the lever-like swivel element with bearing contours for mounting on the busbar and on a wall element,

FIG. 9 shows in a perspective view, a cap-like or pocket-like housing element with opposing wall elements and a receiving space or compartment for the functional element,

FIG. 10 shows in a diagram according to FIG. 1, an example of the conductor terminal,

FIG. 11 shows in a cross-sectional view, the conductor terminal according to FIG. 10 with a closed clamping point,

FIG. 12 shows the conductor terminal according to FIGS. 10 and 11 with a clamping arm of the clamping spring swiveled by means of a swivel element,

FIG. 13 shows in a cross-sectional view, the conductor terminal according to FIGS. 10 to 12 in an open position of the clamping point with the clamping arm locked in place,

FIG. 14 shows in a diagram according to FIG. 13, the conductor terminal with the clamped conductor after the locking connection has been released,

FIG. 15 shows in a perspective view, a functional element with a bearing section for the swivel element,

FIG. 16 shows in a perspective view, a lever-like swivel element with bearing contours for mounting on the functional element and on a wall element,

FIG. 17 shows in a perspective view, the busbar and the swivel element as well as the functional element according to FIG. 15 in the locking connection with the clamping arm of the clamping spring,

FIG. 18 shows in a perspective view, a cap-like or pocket-like housing element with opposing wall elements and an assembly or receiving space for the functional element according to FIG. 15,

FIG. 19 shows in a diagram according to FIGS. 1 and 10, an example of the conductor terminal,

FIG. 20 shows in a sectional diagram, the conductor terminal according to FIG. 19 with a conductor clamped between the clamping spring and the busbar after a locking connection has been released by means of the electrical conductor,

FIG. 21 shows in a perspective view, a functional element of the conductor terminal according to FIG. 20 with a number of functional sections,

FIG. 22 shows in a perspective view, the functional element according to FIG. 20 and the clamping spring with the clamping arm locked in place,

FIG. 23 shows in a perspective view, the busbar of the conductor terminal according to FIG. 19,

FIG. 24 shows in a perspective view, the functional element joined with the busbar according to FIG. 23, and

FIG. 25 shows in a perspective view, a cap-like or pocket-like housing element of the conductor terminal according to FIG. 19 with an assembly or receiving space for the functional element according to FIG. 21.

### DETAILED DESCRIPTION

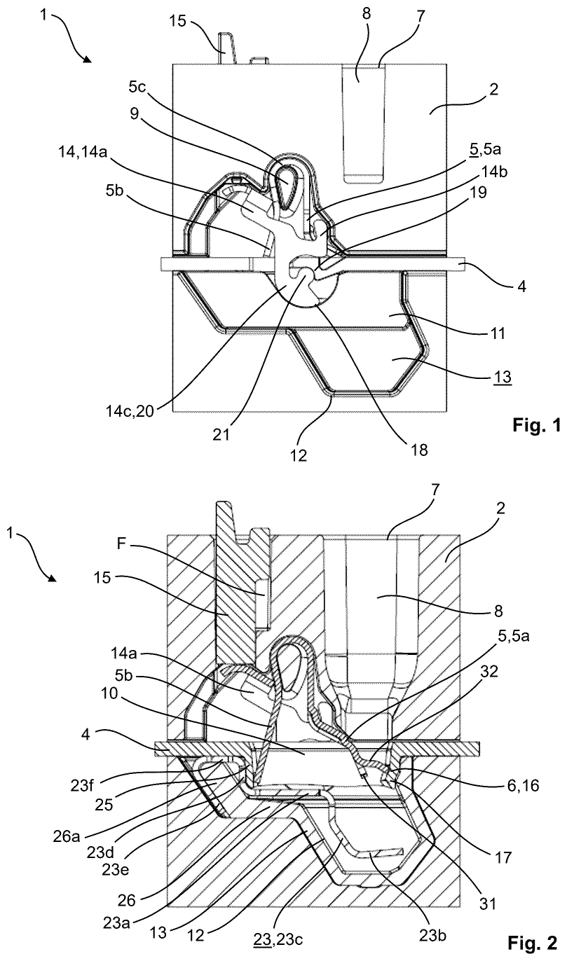

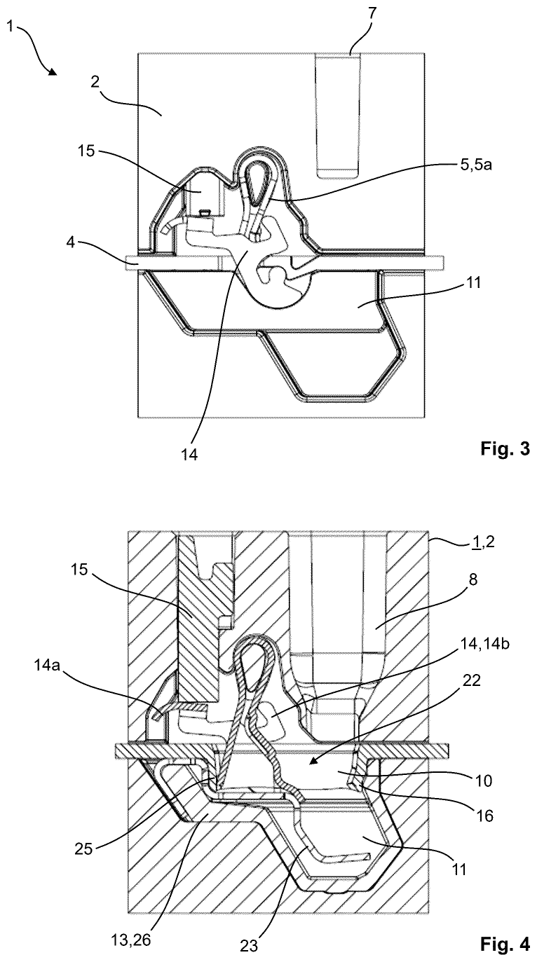

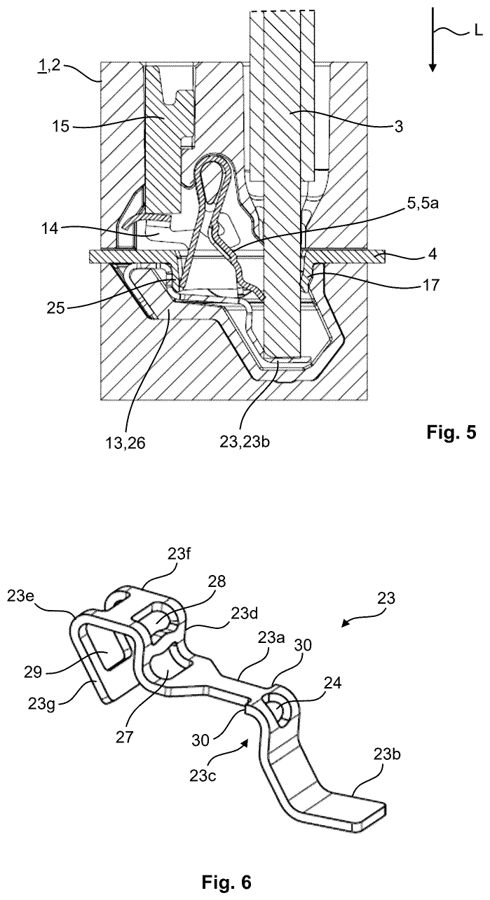

FIGS. 1 to 5 show a conductor terminal 1 in different views, which is accommodated in a housing made of an electrically non-conductive material, in particular a plastic material, which is referred to below as an insulating material housing 2. The conductor terminal 1 is provided and set up for connecting an electrical conductor 3.

The conductor terminal 1 has a busbar 4 and a clamping spring 5, which forms a clamping point 6 for the conductor 3 with the busbar 4. The conductor 3 is routed via an insertion opening 7 and a conductor connecting channel 8 of the (insulating material) housing 2 in the conductor insertion direction L to or into the clamping point 6. The clamping spring 5 has a clamping arm 5a and a contact leg 5b, which is connected to the clamping arm 5a via a spring bow 5c. The clamping spring 5 is positioned or fixed in position in the housing 2 by means of a housing dome 9 that engages in the spring bow 5c.

The busbar 4 has a through-hole opening 10 for the conductor 3. The through-hole opening 10 is designed as a pull-through. In a conductor insertion direction L behind the material through-hole opening 10, a wall element 11 is arranged. The wall element 11 preferably covers or is located in a housing recess 12 of the insulating housing 2. The wall element 11 is preferably a component of a cap-like or lid-like housing part or housing element 13 shown in FIG. 9. This is inserted into the housing recess 12 of the insulating material housing 2. Appropriately, the outer contour of the housing element 12 is adapted to the inner contour of the recess 12, in particular so that the housing element 13 fits into the recess 12 with as little play as possible.

On the busbar 4 and in the wall element 11, a swivel element 14 is mounted, hereinafter also referred to as the rocker arm, which is mechanically coupled to the clamping arm 5a of the clamping spring 5. The swivel element 14 interacts with an actuator element 15 designed as a pusher, which is guided in a sliding movement in a guide channel 16 of the insulating material housing 2. The swivel element 14 is used to open the clamping of the clamping arm 5a at the clamping point 6. In the open clamping shown in FIG. 2, the clamping point 6 is formed between a clamping edge 16 of the clamping arm 5a and a wall or collar section 17 of the busbar 4.

With regard to FIG. 8, the rocker arm 14 has a lever section 14a as a swivel element, which is or can be coupled with the pusher 15. The rocker arm 14 has a contact leg 14b, which rests on the clamping arm 5a of the clamping spring 5. The rocker arm 14 has a bearing leg 14c, which interacts on the one hand with a bearing contour 18 of the wall element 11 and on the other hand with a bearing contour 19 of the busbar 4, preferably forming a bearing and/or a counter bearing for the rocker arm 14. The bearing leg 14c has a disc-like bearing contour 20, which is located in a corresponding, in particular shell-like, bearing section as bearing contour 18 of the wall element 11. The bearing leg 14c has a, in particular mushroom-head-shaped, bearing section 21, which is located in a corresponding, in particular arched or trough-shaped or shell-like bearing section as bearing contour 18 of the busbar 4.

The conductor terminal 1 has a functional element 23. This is arranged in the conductor insertion direction L behind the through-hole opening 10 of the busbar 4 or, in relation to the insertion opening 7, on the rear of the rail of the busbar 4. The functional element 23 is designed as a flexurally elastic spring element, for example made of a spring steel, preferably flat-strip-like.

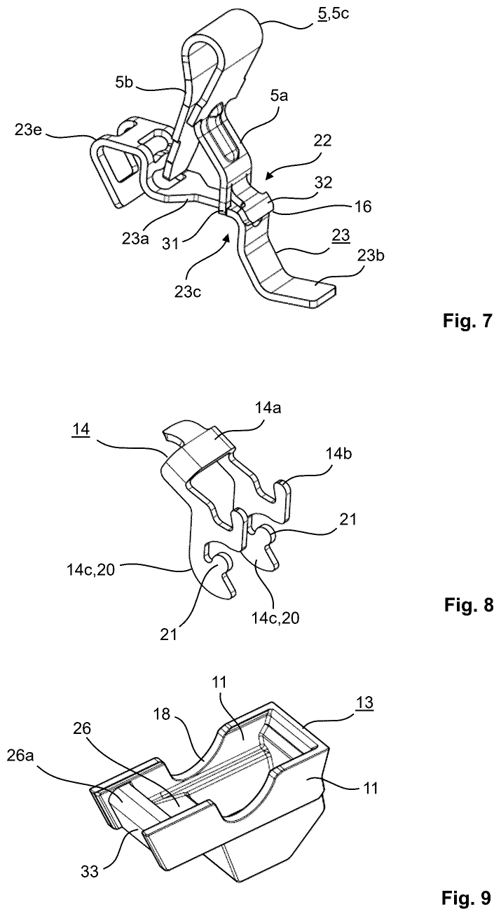

With regard to FIG. 6 as well, the functional element 23 has a locking section 23a for establishing a releasable locking connection 22, which is illustrated in particular in FIGS. 4 and 7, with the clamping arm 5a of the clamping spring 5. The functional element 23 has a release section 23b for releasing the locking connection 22. The release section 23b can be actuated with the conductor 3 under pressure in order to release the locking connection 22. The release section 23b is connected to a bending point or a bending section 23c, which is connected to the locking section 23b. The bending point or bending section 23c has a recess or an opening 24 designed as a hole (FIG. 6) in order to create a particularly suitable or small bending radius.

The functional element 23 has an angle or contact section 23d, in particular as part of a holding section 23e, which is positioned in the direction of the busbar 4. The busbar 4 has a wall or collar section 25, in particular formed by the pull-through or pull-through collar, as contact or contact contour for the angle section 23d or the holding section 23e of the functional element 23. The wall or collar section 25 is oriented in the direction of the conductor insertion L towards the functional element 23. The wall or collar section 25 is provided on the rear of the rail of the busbar 4 facing away from the insertion opening 7. The wall or collar section 25 is formed from the busbar 4 by a (90°) deformation.

With the angle or connection section 23d, the functional element 23 rests on one side of the through-hole opening 10 (outside or contact side) of the wall or collar section 25, preferably in such a way that the angle or connection section 23d and above it the functional element 23 on this side (outside) on the wall or collar section 25 of the busbar 4 is supported, in particular, as or as part of a force chain.

The functional element 23 has a holding section 23e which interacts with a holding or support contour 26 of the wall element 11 or the housing element 13, preferably also with the busbar 4. The functional element, in particular its holding section 23e, has a contact section 23f which is oriented parallel to the busbar 4 and rests on the busbar 4 in the conductor insertion direction L or, in relation to the insertion opening 7 at the rear, in particular outside or adjacent to the through-hole opening 10. In conjunction with the wall or housing side holding or supporting contour 26, the holding section 23e of the functional element 23 is reliably held. In particular, the holding section 23e of the functional element 23 is fixed by a clamp between the busbar 4 and the wall element 11 or the housing element 13.

FIG. 6 shows the spring element 23 with the functional sections, namely the release section 23b and the locking section 23a adjoining it via the bending section 23c, as well as with the adjoining angle section 23d and with the adjoining contact section 23f of the holding section 23e. The angle section 23d, also referred to below as the connecting section, forms the transition between the locking section 23a and the contact section 23f. The contact section 23f is adjoined by a bent insertion section 23g, in particular with an acute angle. This encompasses a section 26a of the holding or supporting contour 26 of the housing element 13 (FIG. 9).

In this example of the functional element 23, the holding section 23e is approximately U-shaped. Desirably, recesses 27, 28, 29 in the bending points between adjacent or adjoining sections 23a, 23d and 23d, 23f or 23f, 23g allow for small bending radii. This can also reduce a release force acting via the release section 23b by means of the conductor 3 into the functional element 23.

With regard to FIG. 7, it can also be seen that in the area of the locking section 23a, two contact or locking edges 30 are formed as a locking contour or locking element by means of a notch made as a taper in the locking section 23a in the example. A locking tab 31 corresponds to the respective contact or locking edge 30 as a locking contour or locking element on the clamping arm 5a of the clamping spring 5, forming the locking connection 22, in that the respective locking tab 31 engages behind the corresponding locking edge 30.

As can be seen comparatively clearly in FIG. 7, the clamping arm 5a of the clamping spring 5 has a bending section 32 oriented in the direction of the clamping point 6, which forms the clamping edge 16 on the free-end side. For this bending section 32, the respective locking tab 31 extends at an acute angle and, in the locking connection, approximately perpendicular or at a right angle to the locking section 23a of the functional element 23.

FIG. 9 shows the pocket-like or cap-like housing element 13. This forms two parallel wall elements 11 for the support of the swivel element 14 at opposite bearing points of each of the wall elements 11 in the form of the arch-shaped or shell-like bearing contours 18. Between the wall elements 11 there is an insertion and/or receiving space for the functional element 23. On a side wall 33 connecting the wall elements 11, the holding or supporting contour 26 is formed.

In the assembled state, the housing element 13, in particular an area of the housing opening, encloses the pull-through collar or the wall or collar sections 17, 25 of the busbar 4 at least in some areas. This means that the housing element 13 with the functional element 23 therein and other components of the conductor terminal 1, in particular the busbar 4, the clamping spring 5 and/or the rocker arm 14, can be provided as a pre-assembled unit or inserted into the insulating material housing 2.

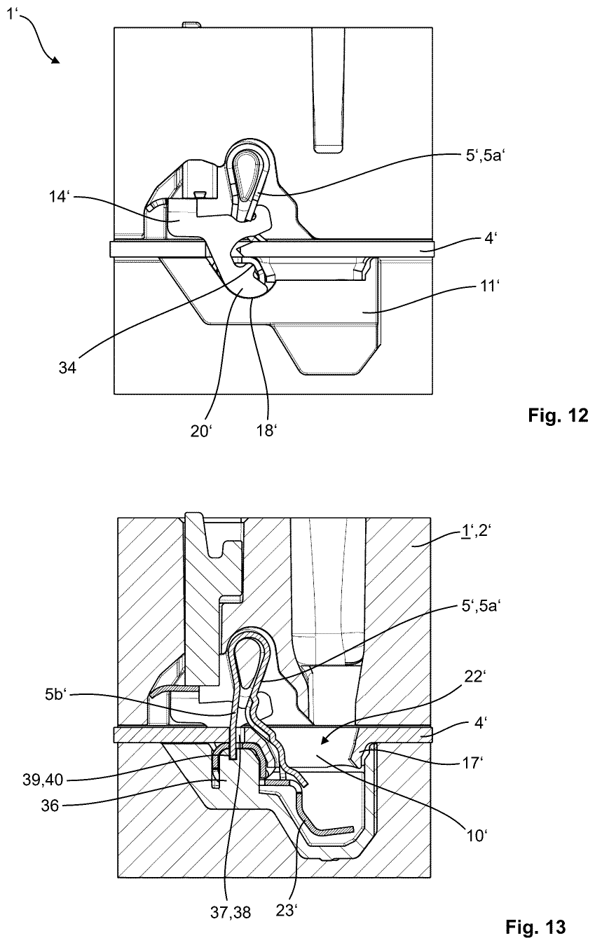

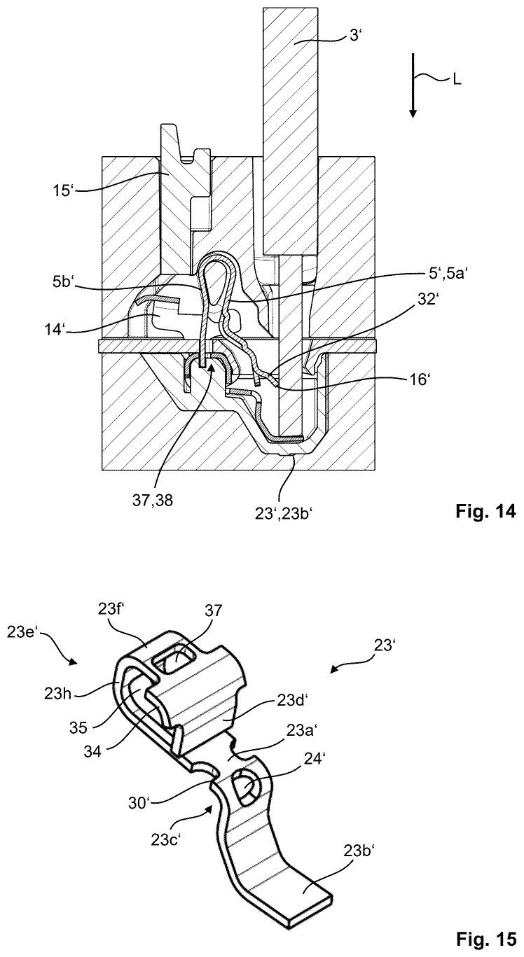

In the example according to FIGS. 10 to 18, the conductor terminal 1′ in turn, which is accommodated in an insulating material housing 2′ or encompasses it, has a busbar 4′ and a clamping spring 5′, which forms a clamping point 6′ for an electrical conductor 3′ with the busbar 4′, as well as a clamping arm 5a′ and a contact leg 5b′, which is connected to the clamping arm 5a′ via a spring bow 5c′. In this example, the conductor terminal 1′ is comparatively narrow, for example only about 3.5 mm, or with a correspondingly small size or small dimension.

The busbar 4′ has a through-hole opening 10′ designed as a pull-through. A wall element 11′ arranged in a conductor insertion direction L behind the through-hole opening 10′ is preferably a component of a cap or lid-like housing part or housing element 13′ shown in FIG. 18, which is inserted or can be inserted into the (insulating material) housing 2′.

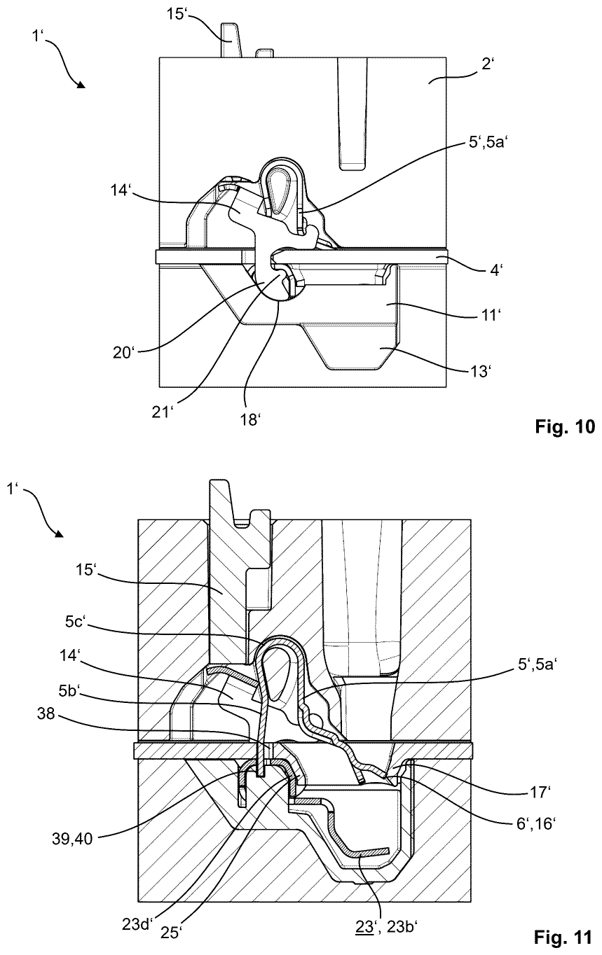

A swivel element or rocker arm 14′ is mounted on the busbar 4′ and in the wall element 11′, which is mechanically coupled with the clamping arm 5a′ of the clamping spring 5′ for opening the clamping of the clamping arm 5a′ at the clamping point 6′ and interacts with a pusher 15′ guided by sliding movement. In the open clamping shown in FIG. 11, the clamping point 6′ is formed between a clamping edge 16′ of the clamping arm 5a′ and a wall or collar section 17′ of the busbar 4′.

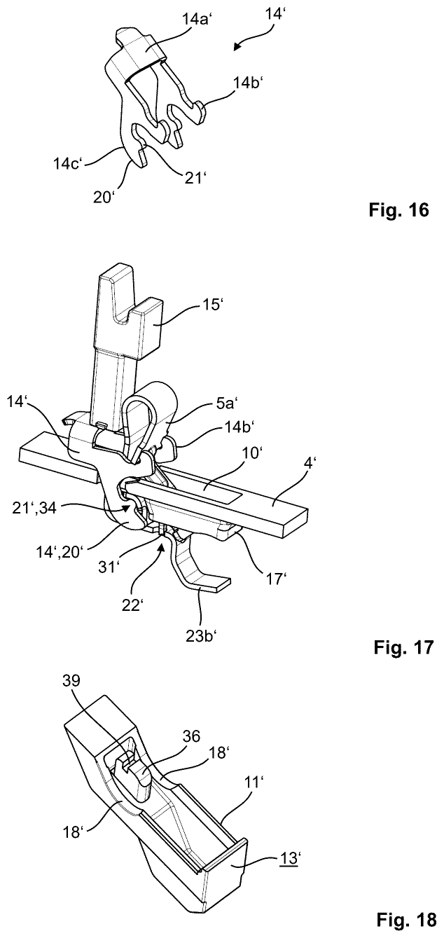

FIG. 16 shows the rocker arm 14′ as a swivel element with a lever section 14a′, which is or can be coupled with the pusher 15′, and with a contact leg 14b′ attached to the clamping arm 5a′ as well as with a bearing leg 14c′. This interacts on the one hand with a bearing contour 18′ of the wall element 11′ and on the other hand with a bearing contour 34 of the functional element 23′, preferably forming a bearing and/or a counter bearing for the rocker arm 14′. The bearing leg 14c′ has a disc-like bearing contour 20′, which is inserted in a corresponding, in particular shell-like, bearing section as the bearing contour 18′ of the wall element 11′. The bearing leg 14c′ has a bearing section 21′, in particular mushroom-head-like or mushroom-head-shaped, which lies (sits) in the corresponding bearing contour 34 of the functional element 23′ of the busbar 4.

FIG. 15 shows the functional element 23′ of the conductor terminal 1′. The functional element 23′ has a locking section 23a′ for the creation of a releasable locking connection 22′ with the clamping arm 5a of the clamping spring 5′, analogous to the example according to FIG. 7. The functional element 23′ has a release section 23b′ that can be actuated with the conductor 3′ under pressure for releasing the locking connection 22′. The release section 23b′ is connected to the locking section 23b′ via a bending point 23c′.

The functional element 23′ has a bearing or functional section 23h for supporting the swivel element 14′. The bearing or functional section 23h is manufactured by multiple bending to form a bearing sleeve or bearing eye 35. At the bearing or functional section 23h, in a bending area between an angle or connecting section 23d′ and a contact section 23f′ for contact with the busbar 4′, the, or each, bearing contour 34 is formed for the swivel element 14′ designed as a rocker arm 14′. The bearing or functional section 23h has an opening 35 on a section opposite the contact section 23f′.

When inserting the functional element 23′ into the housing element 13′, a joining pin 36 of the housing element 13′ penetrates the opening 35 of the bearing or functional section 23h of the functional element 23′. In particular, the bearing or functional section 23h forms a holding section 23e′ of the functional element 23′ or has the function of such a holding section 23e′, in particular analogous to the example according to FIG. 6.

The functional element 23′ has an insertion or through-hole opening 37, which aligns with a through-hole opening 38 in the busbar 4′. The joining pin 36 of the housing element 13′ has a recess or groove 39, which in turn aligns with the openings 37, 38. The contact leg 5b′ of the clamping spring 5′ has an insertion or joining end on the free end side, which in the recess 39 of the housing element 13′ via the opening 37 of the functional element 23′ and via the opening 28 of the busbar 4′ as insertion element 40. The contact leg 5′ of the clamping spring 5′ is thus arranged outside the through-hole opening 10′ and is positioned or supported on the busbar 4′ or on the functional element 23′ as well as in or on the housing element 13′.

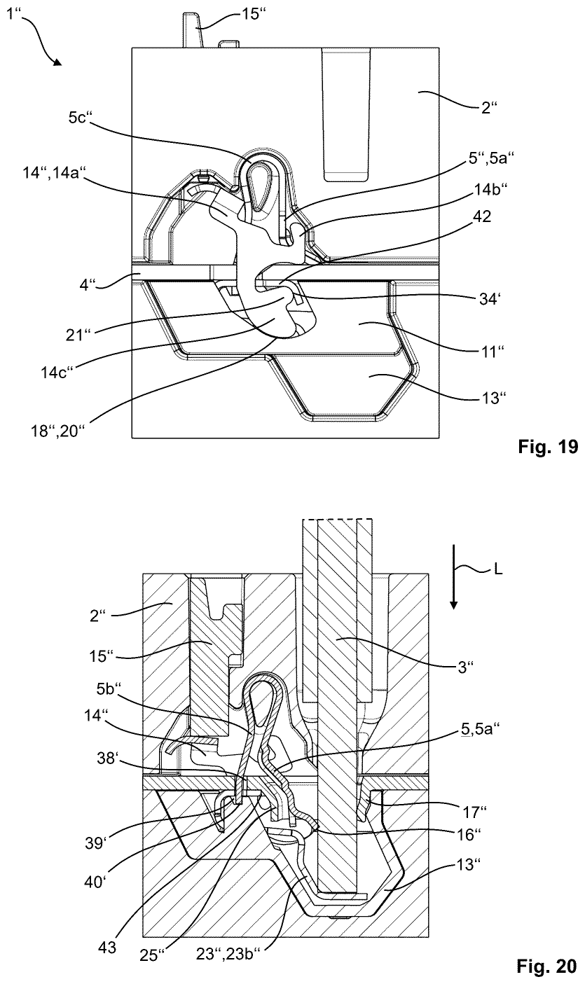

In the example according to FIGS. 19 to 25, the (insulating material) housing 2″ of the conductor terminal 1″ in turn has a busbar 4″ and a clamping spring 5″ with an contact leg 5b″ and with a spring bow 5c″ as well as with a clamping leg 5a″, the clamping edge 16″ of which in turn forms a clamping point 6″ for the electrical conductor 3″. In this example, the conductor terminal 1″ is particularly narrow or with a small size or dimension.

The busbar 4″, which is shown separately in FIG. 23, in turn has a through-hole opening 10″ designed as a pull-through. The busbar 4″ has a wall or collar section 17″ in the area of the through-hole opening 10″, in particular limiting the narrow side, which again serves as a clamping point 6″ for the clamping spring 5″, and a wall or collar section 25″ on the opposite side. In the area of this wall or collar section 25″, the busbar 4″ has a through-hole opening 38″, preferably between recesses 41 opposite each other for the rocker arm 14″ or for its bearing leg 14c″.

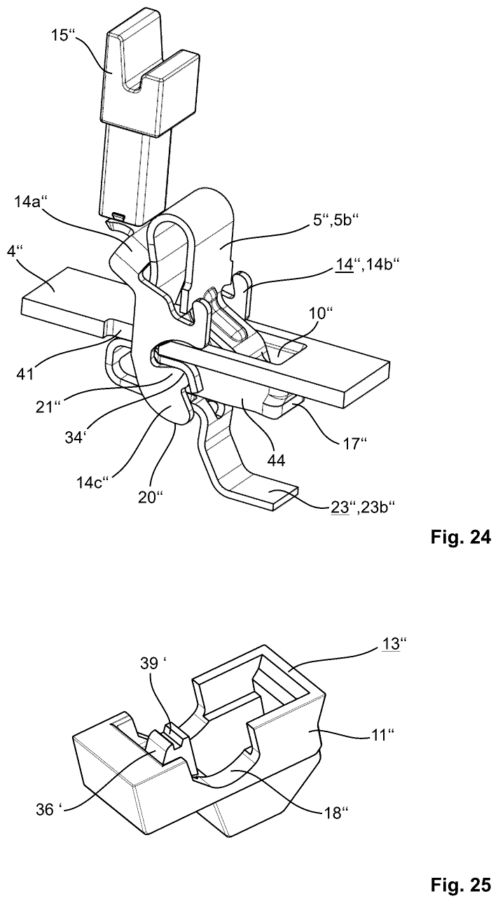

A wall element 11″ arranged in the direction of conductor insertion L behind the through-hole opening 10″ is in turn preferably a component of a cap or cover-like housing part or housing element 13″ shown in FIG. 25, which is inserted or can be inserted into the (insulating material) housing 2″. The housing element 13″ in turn has a joining pin 36′ with a recess or groove 39′.

A rocker arm comparatively clearly recognizable in FIG. 24 as a swivel element 14″ for opening the clamping of the clamping arm 5a″ at the clamping point 6″ or at the wall or collar section 17″ is mechanically coupled to the clamping arm 5a″ of the clamping spring 5″. The rocker arm 14″ in turn has a lever section 14a″ coupled to a pusher 15″ and a contact leg 14b″ attached to the clamping arm 5a″′ as well as a bearing leg 14c″, again preferably two parallel bearing legs 14c″.

The bearing leg 14″ or each bearing leg acts on the one hand with a bearing contour 18″ of the wall element 11″ and on the other hand with a bearing contour 34′ of a functional element 23″ to form a bearing or a counter bearing for the rocker arm 14″. The bearing leg 14c″ has a disc-like bearing contour 20″, which is inserted in a bearing contour 18″, preferably shell-like, of the wall element 11″. The bearing leg 14c″ has a bearing section 21″, in particular mushroom-head-like or mushroom-head-shaped, which is located in a corresponding bearing contour 34′ of the functional element 23″.

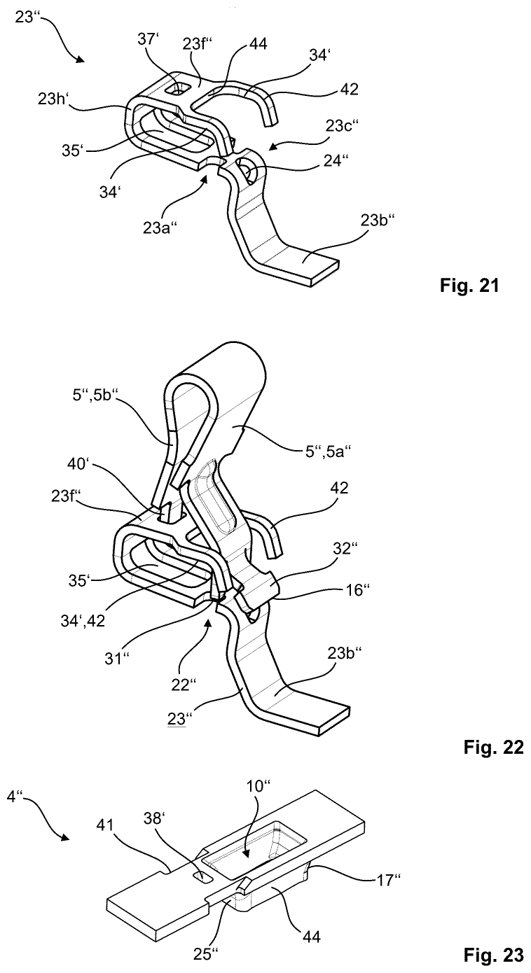

FIGS. 21 and 22 show the functional element 23″ or the clamping spring 5″ locked with the functional element 23″. The functional element 23″ has—analogous to the example according to FIG. 17—a locking section 23a″ for the creation of a releasable locking connection 22″ with the clamping arm 5a″ of the clamping spring 5″. The functional element 23″ has a contact section 23f″ for contact to the busbar 4″ and a release section 23b″ that can be actuated with the conductor 3″ under pressure for releasing the locking connection 22″. The release section 23b″ is connected to the locking section 23a″ via a bending point 23c″, preferably according to those of FIGS. 6 and/or 15.

The functional element 23″ has a bearing or functional section 23h′ for supporting the swivel element or rocker arm 14″. The bearing or functional section 23h′ is formed on or by at least one bearing leg 42, preferably two parallel bearing legs 42. The respective bearing leg 42 extends to the side of the passage opening 10″. In particular, the parallel bearing legs 42 run on both sides of the passage opening 10″. Between the bearing legs 42, or running transversely to the respective bearing leg 42, a contact edge 43 is formed. With this, the contact section 23f″ of the functional element 23″ rests on the outside of the wall or collar section 25″. In other words, the functional element 23″ is supported by the contact edge 43 on the busbar 4″.

The respective bearing leg 42 extends in the direction of the narrow-sided wall or collar section 17″ or in the direction of the clamping edge 16″ or the clamping point 6″ if the clamping arm 5a″ is not locked or in its clamping position on the wall or collar section 17″. In other words, the respective bearing leg 42 runs in the longitudinal direction of the busbar 4″ or parallel to the distance or to an imaginary distance line between the wall or collar sections 25″ and 17″. The respective bearing leg 42, which is suitably bent on the free end side, forms the bearing contour 34′ of the functional element 23″ as a counter bearing for the rocker arm 14″ mounted in the wall-side bearing contour 18″.

With a view to FIG. 24, it can also be seen that in the case of the passage opening 10″, which is designed as a pull-through, the bearing legs 42 of the functional element 23″ run on both sides of a respective longitudinal wall 44 of the pull-through. The respective bearing point of the bearing section 21″ of the rocker arm 14″ is located at the back of the busbar 4″, advantageously directly below the contact point of the contact leg 14b″ of the rocker arm 14″ at the clamping arm 5a″ of the clamping spring 5″.

The conductor terminal 1″ is particularly narrow due to the bearing legs 42 running to the side of the passage opening 10″ or the pull-through and along a part or a section of the length—oriented in the longitudinal direction of the busbar 4″—of the passage opening 10″ or the pull-through. The conductor terminal 1″ therefore has particularly small dimensions, especially in the longitudinal direction of the busbar 4″.

The bearing or functional section 23h′ of the functional element 23″ has an opening 35′ at a section opposite the contact section 23f″. When inserting the functional element 23″ into the housing element 13″, a joining pin 36″ of the housing element 13″ penetrates the opening 35′ of the functional element 23″. The contact leg 5b″ of the clamping spring 5″ has an insertion or joining end 40″, which, in the assembled state of the clamping spring 5″ shown in FIGS. 20 and 22, sits with the functional element 23″ in the push-through opening 38″ of the busbar 4″.

The functional element 23″ has an insertion or push-through opening 37″ in the contact section 23f″, which aligns with the push-through opening 38′ of the busbar 4″. The joining pin 36′ of the housing element 13″ has a recess or groove 39′, which in turn aligns with the openings 37′, 38′. With the insertion or joining end 40′ penetrating the aligned openings 37′, 38′, the contact leg 5b″ of the clamping spring 5″ sits in the recess 39′ of the housing element 13″ when mounted. The contact leg 5b″ of the clamping spring 5″ is thus again arranged outside the passage opening 10″ and supported on the busbar 4″ or on the functional element 23″ and in the housing element 13″. The bearing or counter bearing point between the rocker arm 14″ and the functional element 23″ is positioned outside the through-hole opening 10″ between their narrow-sided wall or collar sections 17″ and 25″.

The claimed invention is not limited to the examples described above. Rather, other variants of the invention can also be derived by the skilled person within the framework of the disclosed claims without departing from the subject matter of the claimed invention. In particular, furthermore, all the individual features described in connection with the various examples or embodiments can also be combined in other ways within the framework of the disclosed claims without departing from the subject matter of the claimed invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal for connecting an electrical conductor, the conductor terminal comprising:
a busbar;
a clamping spring that forms a clamping point with the conductor to clamp the conductor;
at least one wall element; and
a lever-like, swivel element that is mechanically coupled to a clamping arm of the clamping spring to open the clamping at the clamping point,
wherein the swivel element is attached to the wall element and/or to the busbar and/or in or on a section or on a bearing contour of a functional element.

2. A conductor terminal for connecting an electrical conductor, the conductor terminal comprising:
a busbar;
a clamping spring that forms a clamping point with the conductor to connect the conductor; and
a functional element,
wherein the busbar has a passage opening for the conductor to be clamped,
wherein the functional element is arranged in a direction of conductor insertion behind the passage opening of the busbar, and
wherein the functional element has a section and/or a bearing contour to support a swivel element or a lever-like swivel element mechanically coupled to a clamping arm of the clamping spring to open the clamping at the clamping point.

3. A conductor terminal for connecting an electrical conductor, the conductor terminal comprising:
a busbar;
a clamping spring to form a clamping point with the busbar to clamp the conductor;
a functional element forming a locking section to provide a releasable locking connection with a clamping arm of the clamping spring and a contact section or a contact edge,
wherein the busbar has a passage opening for the conductor to be clamped,
wherein the functional element is arranged in a conductor insertion direction behind the passage opening of the busbar,
wherein the busbar, at or in an area of the passage opening designed as a pull-through, has a wall or collar section oriented towards the functional element in the direction of the conductor insertion,
wherein the contact section or the contact edge of the functional element rests against one of the contact side or outside of the wall or collar section facing away from the passage opening, and/or
wherein a contact leg of the clamping spring rests on and/or is supported on an inside of the wall or collar section facing the passage opening.

4. The conductor terminal according to claim 1, wherein in the conductor entry direction behind the passage opening of the busbar, a pocket, cap or lid-like housing element is arranged to form an insertion and/or receiving space and the wall element or at least one wall element.

5. The conductor terminal according to claim 1, wherein the housing element is provided and equipped for the functional element to be accommodated or completely accommodated.

6. The conductor terminal according to claim 1, wherein the housing element is held or mountable or pre-assembled on the busbar and/or on the or a wall or collar section or on the pull-through collar of the busbar and/or encompasses the pull-through collar at least partially or in sections.

7. The conductor terminal according to claim 1, wherein the at least one wall element or the housing element has a bearing section that is arc or circular arc or shell-shaped, in which a corresponding bearing contour of the swivel element is inserted or engages.

8. The conductor terminal according to claim 1, wherein the housing element together with the functional element inserted therein and/or together with the busbar and/or together with the clamping spring adapted to be inserted into the insulating material housing.

9. The conductor terminal according to claim 1, wherein the busbar has at least one bearing contour in the conductor insertion direction on a back of a rail or in an area of the passage opening, and wherein the swivel element has a corresponding bearing contour.

10. The conductor terminal according to claim 1, wherein the functional element has a bearing sleeve or bearing eye forming the functional or bearing section with a bearing contour, and wherein the swivel element has at least one corresponding bearing contour, which interacts with the bearing contour of the functional or bearing section, which is molded or formed from a locking section of the functional element.

11. The conductor terminal according to claim 1, wherein the functional element has at least one bearing leg running laterally towards the passage opening of the busbar or has two bearing legs running on both sides of the passage opening with the formation of a bearing contour, and wherein the swivel element has at least one corresponding bearing contour that interacts with the bearing leg or the bearing contour by forming a counter bearing for the swivel element.

12. The conductor terminal according to claim 1, wherein the functional element has a release section for releasing the locking connection, which interacts with the conductor, and/or wherein the functional element has a locking section with a locking contour connected to the release section via a knee-like, bending point, and/or wherein the functional element has an angular section positioned in the direction of the busbar, and/or wherein the functional element has a holding section, which interacts with a holding contour of the wall element or the housing element, and/or wherein the functional element has a locking section with a locking contour that is angled with respect to the release section, as well as an angular section adjacent to it in the direction of the busbar, as well as a holding section adjacent to it, which interacts with a holding contour of the wall element or the housing element, and/or wherein the functional element or its holding section has a recess or opening aligned with an opening of the busbar and the clamping spring or its contact leg, and has an insertion element that is pin-like or tab-like or flat ribbon-like, which engages in the recess or opening of the functional element via the opening of the busbar.

13. The conductor terminal according to claim 1, wherein the functional element has a contact section substantially in parallel to the busbar in the conductor insertion direction on a rail rear side.

14. The conductor terminal according to claim 1, wherein the functional element or the holding section has a contact section parallel to the busbar and an insertion section running at an angle to the contact section or an is acute-angled and is adapted to sit or be inserted into an insertion contour of the wall element or the housing element.

15. The conductor terminal according to claim 1, wherein the holding section of the functional element is designed as a functional or bearing section or is shaped in the manner of a bearing sleeve or bearing eye for the swivel element for supporting at least one corresponding bearing element or bearing section of the swivel element.

16. The conductor terminal according to claim 1, wherein a recess is provided in the angular section of the functional element, and/or wherein the angular section of the functional element rests outside the passage opening of the busbar on a wall or collar section of the busbar opposite the clamping point, and/or wherein the functional element is held in sections between the busbar and a housing or support contour of the wall element or the housing element and is fixed by a clamp.

17. The conductor terminal according to claim 1, wherein the functional element has a notch forming at least one contact or locking edge and the clamping arms of the clamping spring has at least one locking tab that engages behind the corresponding locking or contact edge to form the locking connection, and/or wherein the clamping arm of the clamping spring has a bending section oriented in the direction of the clamping point with a free end clamping edge, and/or wherein the clamping arm of the clamping spring has at least one locking element that is pin-like or tab-like, and which runs at an angle to a bending section oriented in a direction of the clamping point with a free end clamping edge.
